(19) United States
(12) Patent Application Publication
(10) Pub. No.: US 2004/0060479 A1
(43) Pub. Date: Apr. 1, 2004

(54) Method for manufacture of simulated stone products

(76) Inventor: Sam Valenzano, Woodbridge (CA)

Correspondence Address: Eric Fincham, 316 Knowlton Road, Lac Brome, QC, J0E 1V0, CA

(21) Appl. No.: 10/260,851

(22) Filed: Sep. 30, 2002

(51) Int. Cl. C04B 14/00; C04B 16/00; C04B 24/00; C04B 28/10

(52) U.S. Cl. 106/716; 106/724; 106/725; 106/726; 106/711; 106/737

(57) ABSTRACT

A concrete composition and a method for forming a simulated stone product such as granite or marble uses a mixture of cement, sand, water, latex, silicate and a superplasticizer, the mixture being poured in a mold wherein at least one surface is of a smooth water impervious material and is preferably coated with a release agent, the poured product then having a controlled moisture release rate. The simulated stone product can be formed in any different configuration desired and is characterized by having a high gloss reading.

### FIELD OF THE INVENTION

The present invention relates to concrete structures and to a method for manufacturing simulated stone products having a glossy surface.

### BACKGROUND OF THE INVENTION

The use of a polished stone as a decorative, functional and long lasting construction material is well known in the art. Two such materials are marble and granite which are frequently used in the form of panels. Thus, the panels may be used as wainscoting in commercial buildings and as well, have recently received increased use and popularity as a flooring material and for kitchen counters. However, some factors restrict the use of these materials including the price and weight of the product. For many uses, the slabs must be relatively thick as they can be dense and brittle. This makes the product extremely heavy and therefore difficult to transport and install.

Over the years, many different attempts have been made to manufacture a product which can have the appearance of marble or granite. These prior art proposals include several processes for covering a substrate with a texture simulated marble surface which will have color pigments therein. Also, it has been proposed in the art to use various resins or polymer compositions to provide a material which can simulate a stone material such as marble or granite.

### SUMMARY OF THE INVENTION

It is an object of the present invention to provide a method for the manufacture of a simulated stone product which is formed from a concrete mixture and which has a glossy surface.

It is a further object of the present invention to provide a novel panel formed of concrete and having a surface of a glossy stone appearance.

It is a further object of the present invention to provide a method for the manufacture of a molded simulated stone product having a glossy polished like surface.

It is a further object of the present invention to provide novel concrete mixes which can be formed into simulated stone products.

According to one aspect of the present invention, there is provided a concrete mixture comprising, on a weight basis, between 25% and 55% of Portland cement, between 20% and 50% of a material selected from the group consisting of sand and ground recycled glass and combinations thereof, between 6% and 13% of water, between 3% and 11% of latex, and between 0.7% and 2% of a superplasticizer.

According to a further aspect of the present invention, there is provided a method of forming a simulated stone product comprising the steps of forming a concrete slurry comprising, on a weight basis, between 25% and 55% of Portland cement, between 20% and 50% of a material selected from the group consisting of sand and ground recycled glass and combinations thereof, between 6% and 13% of water, between 3% and 11% of latex, and between 0.7% and 2% of a superplasticizer, pouring the concrete slurry into a mold, at least one surface of the mold having a smooth water impervious surface, the smooth water impervious surface having been coated with a release agent, and controlling the rate of evaporation of water from the slurry in the mold.

According to a further aspect of the invention, there is provided a method of forming a simulated stone panel wherein one surface of the panel has a smooth glossy stone like appearance, the method comprising the steps of preparing a concrete composition, pouring the concrete composition into a mold having a lower surface of a smooth water impervious nature and having a release agent thereon, covering the poured concrete composition to minimize loss of moisture therefrom, and removing the panel after the panel has cured sufficiently to be handled, and placing the panel on a side marginal edge such that both a front surface and a back surface are equally exposed to an ambient environment.

According to a still further aspect of the invention, there is provided a simulated stone product comprising cured concrete having at least one outer surface, the outer surface having a gloss rating equal to that of polished granite.

According to a still further aspect of the invention, there is provided a simulated stone product comprising cured concrete in the form of a column, the column comprising an outer layer of concrete, the outer layer having a glossy outer surface, and an inner portion of the column being made of a material lighter than concrete.

As stated above, there is provided a concrete composition which is suited for the manufacture of a simulated stone product. Preferably, the concrete composition is formed as a two component mix—a dry mix and a wet mix. The dry mix will include the Portland cement, the silica sand/recycled glass, lime stone and optionally a small portion of filler and dry silicates. In a preferred embodiment, the filler can include chopped fiberglass, styrofoam, mineral fillers, etc. Both fillers are preferably present in relatively small percentages—i.e. under 5% by weight.

The wet mix portion of the composition preferably includes water, a latex, a silicate(s), hardeners and a superplasticizer. Optionally, the wet mix may also include, in a very small concentration, an anti-foaming agent. This agent may be present in an amount of between 0.01% and 0.1% by weight.

Naturally, it will be understood that many different ingredients may be added to the mixture. Thus, the silica sand may have a portion thereof replaced by recycled ground glass or equivalent materials. In a preferred embodiment, the mixture will also incorporate lime stone, the lime stone being present in an amount of between 10% and 15% by weight.

The composition may also contain other components which enhance the properties thereof. Thus, in one embodiment, the composition may include a complex catalysed silicate such as is marketed under the trademark “MOXIE 1800 SUPER-ADMIX” by Moxie International. This additive has several properties enabling the concrete to better resist materials such as chlorides, oil, gas, acids, solvents, bacteria, etc.

The wet mix and the dry mix are then blended together in a conventional manner using any suitable mixing equipment. A base color or colors may be then added to the mixture along with one or more secondary colors to simulate veins such as are normally found in natural stone products. The color may be mixed in by using what is known as a marble cake effect process.

The concrete mixture may then be poured into an appropriate mold for the product to be manufactured. Thus, the product may be manufactured as a sheet or slab, as a post or column, or in any other shape for which a mold may be manufactured. In order to obtain the glossy finish of the simulated stone, the mold surface must be formed of a very smooth and water impervious material. For these purposes, a glass or certain plastic materials may be utilized. The mold surface must be clean and is preferably coated with a release agent, many such release agents being known to those skilled in the art.

In forming a slab or panel like configuration for use in tiles, kitchen counters, wall panels, etc, the glass is placed on the bottom of the mold and the concrete mixture is poured. For maximum control of color effect, the concrete composition is poured wherein the opening of the pouring container is facing in the direction in which the mold is being filled. The thickness of the panel or sheet may vary and may be as thin as 3 mm. Naturally, thicker panels may be utilized.

The concrete mixture is then allowed to slowly cure. Preferably, a cover is placed on the back of the mold to prevent a too rapid evaporation of water. Any suitable material known to those skilled in the art may be utilized for such purposes.

Once the panel has cured sufficiently to have structural integrity to permit the handling of the same, it is preferably removed from the mold and stood on one of its marginal edges such that the planar surfaces are in a vertical orientation. This permits even exposure of both the front and back surfaces of the panel to the ambient atmosphere and helps to prevent cracking/warping in the panel.

When molding other multi-dimensional objects, one can provide a mold coated with a suitable smooth material as above mentioned and pour the concrete into the mold. After a suitable curing period (normally between 1 and 14 days), the mold is removed.

To form columns or posts which are both decorative and lightweight, an interior filling material such as a styrofoam may be utilized. The concrete mixture is then poured about the center portion of styrofoam or the like to fill the mold.

The present invention provides a product wherein at least one surface has a very high gloss or refractive index similar to that of polished granite or marble.

Having thus generally described the invention, reference will be made to the example of an embodiment of the present invention.

### EXAMPLE 1

A dry mix comprises the following ingredients:

| | | | |
|---|---|---|---|
| Portland cement | 40 | kgs | 49.14% |
| Silica sand | 20 | kgs | 24.57% |
| Fiberglass chop mix | 0.25 | kg | 0.31% |
| Wallastonite | 0.25 | kg | 0.31% |

The above materials were mixed together.

A wet mix comprises the following ingredients:

Dru-Plus Anti-foaming

| | | |
|---|---|---|
| Water | 9.1 kgs | 11.18% |
| Latex Mid-Grade | 6.9 kgs | 8.48% |
| Meta-Max Alumin-Silicat | 3.8 kgs | 4.67% |
| Meladyne Superplasticizer | 1.1 kgs | 1.35% |

The ingredients were mixed together.

Subsequently, the wet mix and dry mix were mixed in a cement mixer for a period of time of 15 min-30 min.

The product was then poured into a mold comprised of a glass surface.

After curing for 1 day, the product was removed from the mold and placed on a side edge for 14 days while evaporation was controlled.

The final product had a high gloss reading similar to that of a natural stone product that has been machine polished to a high gloss.

### EXAMPLE 2

A dry mix comprises the following ingredients:

| | | | |
|---|---|---|---|
| Portland cement | 40 | kgs | 33.84% |
| Silica sand | 47 | kgs | 39.77% |
| Fiberglass chop mix | 0.25 | kg | 0.21% |
| Wallastonite | 0.25 | kg | 0.21% |

The above materials were mixed together.

A wet mix comprises the following ingredients:

| | | | |
|---|---|---|---|
| Dru-Plus Anti-foaming | 0.057 | kg | 0.05% |
| Water | 10.0 | kgs | 8.46% |
| Latex Mid-Grade | 5.0 | kgs | 4.23% |
| Meta-Max Alumin-Silicat | 1.9 | kgs | 1.61% |
| Meladyne Superplasticizer | 1.3 | kgs | 1.10% |

The ingredients were mixed together.

Subsequently, the wet mix and dry mix were mixed in a cement mixer for a period of time of 15 min-30 min.

The product was then poured into a mold comprised of a glass surface.

After curing for 1 day, the product was removed from the mold and placed on a side edge for 14 days while evaporation was controlled.

The final product had a high gloss reading similar to that of a natural stone product that has been machine polished to a high gloss.

It will be understood that the above described examples are for purposes of illustration only and changes or modifications may be made thereto without departing from the spirit and scope of the invention.

I claim:

1. A concrete mixture comprising, on a weight basis:
between 25% and 55% of Portland cement;
between 20% and 50% of a material selected from the group consisting of sand and ground recycled glass and combinations thereof;
between 6% and 13% of water;
between 3% and 11% of latex; and
between 0.7% and 2% of a superplasticizer.

2. The concrete mixture of claim 1 wherein said Portland cement is present in an amount of between 30% and 45% by weight, said material selected from a group consisting of sand and ground recycled glass and combinations thereof is present in an amount of between 30% and 40% by weight, said water is present in an amount of between 8% and 12% by weight, said latex is present in an amount of between 4% and 8% by weight, and said superplasticizer is present in an amount of between 1% and 2% by weight.

3. The concrete mixture of claim 2 further including lime stone, said lime stone constituting between 10% and 14% by weight of the mixture.

4. The concrete mixture of claim 3 wherein said mixture further contains between 1% and 4% by weight of a silicate.

5. The concrete mixture of claim 2 wherein said superplasticizer comprises a sulfonated melamine formaldehyde condensate.

6. The concrete mixture of claim 2 further including a filler, said filler being present in an amount of between 0.25% and 1% by weight.

7. The concrete mixture of claim 6 wherein said filler is selected from a group of materials consisting of chopped fiberglass and mineral fillers, and combinations thereof.

8. The concrete mixture of claim 4 further including a complex catalysed silicate in an amount of between 0.25% and 0.45% by weight.

9. A method of forming a simulated stone product comprising the steps of:
forming a concrete slurry comprising, on a weight basis:
between 25% and 55% of Portland cement;
between 20% and 50% of a material selected from the group consisting of sand and ground recycled glass and combinations thereof;
between 6% and 13% of water;
between 3% and 11% of latex; and
between 0.7% and 2% of a superplasticizer;
pouring said concrete slurry into a mold, at least one surface of the mold having a smooth water impervious surface, said smooth water impervious surface having been coated with a release agent; and
controlling the rate of evaporation of water from said slurry in said mold.

10. The method of claim 9 wherein said Portland cement is present in an amount of between 30% and 45% by weight, said material selected from a group consisting of sand and ground recycled glass and combinations thereof is present in an amount of between 30% and 40% by weight, said water is present in an amount of between 8% and 12% by weight, said latex is present in an amount of between 4% and 8% by weight, and said superplasticizer is present in an amount of between 1% and 2% by weight.

11. The method of claim 10 wherein the step of forming a concrete slurry further comprises the step of adding to said slurry between 10% and 14% by weight of lime stone.

12. The method of claim 10 wherein said superplasticizer comprises a sulfonated melamine formaldehyde condensate.

13. The method of claim 10 further including a filler, said filler being present in an amount of between 0.5% and 1% by weight.

14. The method of claim 13 wherein said filler is selected from a group of materials comprising chopped fiberglass and mineral fillers, and combinations thereof.

15. A method of forming a simulated stone panel wherein one surface of said panel has a smooth glossy stone like appearance, the method comprising the steps of:
preparing a concrete composition;
pouring said concrete composition into a mold having a lower surface of a smooth water impervious nature and having a release agent thereon;
covering said poured concrete composition to minimize loss of moisture therefrom; and
removing said panel after said panel has cured sufficiently to be handled, and placing said panel on a side marginal edge such that both a front surface and a back surface are equally exposed to an ambient environment.

16. The method of claim 13 wherein the step of preparing a concrete composition comprises mixing together, on a weight basis:
between 25% and 55% of Portland cement;
between 20% and 50% of a material selected from the group consisting of sand and ground recycled glass and combinations thereof;
between 6% and 13% of water;
between 3% and 11% of latex; and
between 0.7% and 2% of a superplasticizer.

17. A simulated stone product comprising cured concrete having at least one outer surface, said outer surface having a gloss rating equal to that of polished granite.

18. A simulated stone product comprising cured concrete in the form of a column, said column comprising an outer layer of concrete, said outer layer having a glossy outer surface, and an inner portion of said column being made of a material lighter than concrete.
